(19) United States
(12) Patent Application Publication
(10) Pub. No.: US 2024/0296022 A1
(43) Pub. Date: Sep. 5, 2024

(54) METADATA-DRIVEN VISUALIZATION LIBRARY INTEGRATION

(71) Applicant: Kobai, Inc., San Ramon, CA (US)

(72) Inventors: Ryan Oattes, Burlington (CA); Irma Verduzco Rodriguez, Dublin, CA (US)

(21) Appl. No.: 18/594,229

(22) Filed: Mar. 4, 2024

Related U.S. Application Data
(60) Provisional application No. 63/449,716, filed on Mar. 3, 2023.

(51) Int. Cl. G06F 8/34

(52) U.S. Cl. CPC G06F 8/34

(57) ABSTRACT

Methods and systems are provided to generate an interface authoring interface, which allows for selection of visualization configuration properties from a plurality of visualization libraries. The methods and systems further receive a selection of a subset of visualization configuration properties from at least one visualization library of the plurality of visualization libraries, including selection of at least one user-interface element that virtualizes executable code for enabling respective visualization configuration property. The methods and systems further configure a visualization authoring interface based on the selection received via the interface authoring interface, where the visualization authoring interface is configured using the executable code.

### INTRODUCTION

The present disclosure is directed to improving the user interface interactions and reducing the requirement of manually inputting executable code to achieve library integration (e.g., for visualization authoring application). More specifically, the present disclosure is directed to providing an interface authoring user interface that allows for making selections that virtualize executable code for library integration in a visualization interface.

### SUMMARY

Open-source web visualization libraries have matured to offer robust support and flexibility, thereby becoming an important tool for application developers. Such a shift has also initiated a notable trend in enterprises developing the visualization elements of custom applications in-house instead of relying on stand-alone commercial visualization tools. Although these applications are mainly useful for specific use cases, for example providing a fixed dashboard interface of business metrics, to expand utilization of these libraries into general purpose applications providing user-configurable visualizations across many potential use cases require application developers to extensively integrate the library or libraries by manually coding them into the application software. This often means providing a user form to manipulate settings made available by the library and writing specific code (e.g., functions to call and configure the library). Maintenance of these custom additions to the software code can further be cost intensive. For example, a gap in the coverage of one particular library may not be discovered until later, requiring manual integration of an additional library.

One approach to avoid this requirement of manually coding the libraries into the application software is to present a user interface with all possible elements and configuration settings available in all the libraries. This is counterproductive because the space on any user interface is limited and because providing the user with thousands (or more) elements and their configuration settings is cumbersome.

In another approach libraries or portions of libraries are added manually by an administrator writing a code for making a certain library function available in an interface. This approach is cumbersome and not user friendly, resulting in poor efficiency because manual coding is inefficient and time consuming. To eliminate the need for manual software development (coding, compilation, testing, etc.) and maintenance in the initial and incremental integration of open source visualization libraries and to avoid display of user interface that includes all possible elements of all possible libraries, the subject matter of this disclosure provides for generating a interface authoring interface that that virtualizes executable code, in order to achieve library integration in a visualization authoring interface without the requirement of manually adding to the software, thereby allowing for rapid development of flexible visualization.

The present disclosure further provides several embodiments of authoring interfaces. The top-level authoring interface, referred to herein as the interface authoring interface, is an interface available, for example, to administrators of an organization. The administrators may use the interface authoring interface to select visualization configuration properties from a plurality of visualization libraries for the elements that the administrators would like to be available, for example, to other users of their organization as part of a visualization authoring interface.

Once the system receives a selection of a subset of visualization configuration properties from at least one visualization library of the plurality of visualization libraries, the system then virtualizes executable code for enabling respective visualization configuration properties. Based on the selections received, the system the configures a second level authoring interface, referred to herein as the visualization authoring interface, which is the interface available, for example, to users in the course of their use of the application. The system configures the visualization authoring interface based on the selection received via the interface authoring interface, using the executable code, such that the users are presented with the elements and their setting as selected by their administrator.

By using two layers of authoring interfaces and allowing for the incorporation of elements and configuration settings from numerous libraries at the same time, the present disclosure prevents the need for manually coding in libraries into the application software code and optimizes the use of space on the user interface but not filing the visualization authoring interface (e.g., available to all users in an organization) with thousands of unnecessary elements and their configurations settings.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts an interface authoring interface to allow used to select configuration settings according to an embodiment of the present disclosure;

FIG. 2 depicts a second level of the interface authoring interface allowing further customization to the administrator, according to an embodiment of the present disclosure;

FIG. 3 depicts a code generation and custom code edit screen as part of the interface authoring interface, according to an embodiment of the present disclosure;

FIG. 4 depicts a first selection screen of a visualization authoring interface, according to an embodiment of the present disclosure;

FIG. 5 depicts a second selection screen of a visualization authoring interface, according to an embodiment of the present disclosure;

FIG. 6 depicts a third selection screen of a visualization authoring interface, according to an embodiment of the present disclosure;

FIG. 7A shows a generalized embodiment of a device usable to provide data processing and visualization, according to an embodiment of the present disclosure;

FIG. 7B shows a diagram of an illustrative system for performing data analysis and user interface presentation, according to an embodiment of the present disclosure; and

FIG. 8 shows a flowchart of an illustrative process to generate a visualization authoring interface, according to an embodiment of the present disclosure.

FIG. 9A shows a flowchart of an illustrative process for library mapping and chart authoring, according to an embodiment of the present disclosure;

FIG. 9B shows another flowchart of an illustrative process for library mapping and chart authoring, according to an embodiment of the present disclosure;

FIG. 9C shows another flowchart of an illustrative process for library mapping and chart authoring, according to an embodiment of the present disclosure;

FIG. 9D shows another flowchart of an illustrative process for library mapping and chart authoring, according to an embodiment of the present disclosure; and and

FIG. 9E shows yet another flowchart of an illustrative process for library mapping and chart authoring, according to an embodiment of the present disclosure.

### DETAILED DESCRIPTION

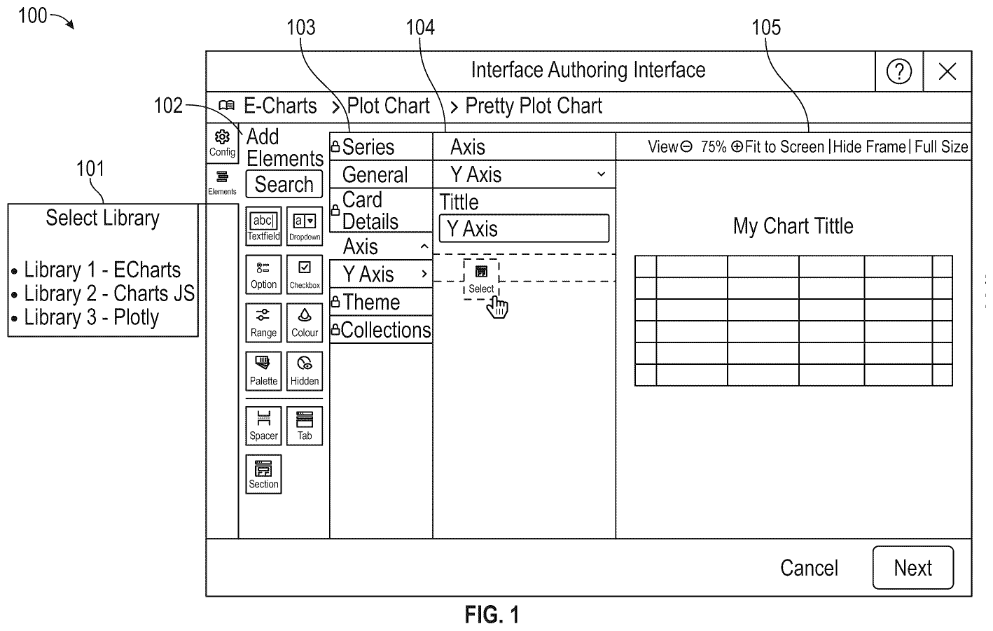

FIG. 1 depicts an exemplary interface authoring interface 100 to allow for selection of configuration settings, in according to some embodiments of the present disclosure. An interface authoring interface 100, as depicted in an example embodiment in FIG. 1, allows a user (e.g., in an administrative position) to set a list of configuration settings in an application (e.g., an application that comprises visualization authoring interface). The system may generate the interface authoring interface 100 which allows a user (e.g., an administrator) to limit or expand the options available to other users while using a visualization application (e.g., via visualization authoring interface) to carry out specific tasks. For example, the system may generate for display a user interface to allow a user to use visualization authoring interface to generate a bar graph (e.g., based on data stored in a database). To enable such functionality, the system may generate for display an interface authoring interface 100 to allow another user (e.g., an administrator) to select a specific set of configuration setting (titles of the graph, location of the titles, limits on the number of items on each axis, location of the axes, etc.) available from one or more visualization libraries that the user may be able to select or alter while using the visualization authoring interface. The interface authoring interface 100 virtualizes code generation for the visualization authoring interface, e.g., by displaying visual interface elements, that when selected, result in generation or insertion of executable code for accessing specific elements of one or more visualization libraries via visualization authoring interface. While certain actions describes above and below refer to certain user interface inputs being provided by an “administrator” or “an administrator user,” one skilled in the art would appreciate that such inputs may be received in any fashion, e.g., from any suitable user of the system.

As shown in the FIG. 1, the system generates for display interface authoring interface 100 that allows administrator to select which library to use from a list of libraries 101 to be able to access a full list of configuration setting options for that library. Although three different library options are depicted in FIG. 1, it is known to one of ordinary skill in the art that this is show only as an exemplary embodiment and the number of different libraries may be more or less than the ones depicted in FIG. 1.

Once the input selecting the library from the list of libraries 101 is received by the system, via the generated interface authoring interface 100, the system may generate for display a list of elements 102 offered by that library for selection. The user interface may allow as many elements as needed to be selected from element list 102. The list of elements 102 displayed by the interface authoring interface 100 may further include sub elements which may be shown in a separate list 103 and presented for selection by user input. In some embodiments, interface authoring interface 100 may further allow the administrator to further fine tune the element settings to be included in the selected element list 104. The selected item list may be used by the system to form the complete selections that will eventually be generated by the system and displayed in the visualization authoring interface, as further described below. In some embodiments, each selection via interface authoring interface 100 results in generation of appropriate executable code that allows the visualization authoring interface to access selected elements functionalities from the selected libraries. In some embodiments, items may be added via interface authoring interface 100 using a search function. In some embodiments, items may be added via interface authoring interface 100 using recommendation provided by the system.

The system may further generate for display user interface elements that allow for user interface input to fill the selected list 104 with as many or as few items as needed, by using the generated interface authoring interface 100. In some embodiments, the system generates for display a preview visualization that allows the administrator user to see the work product each selected element's configuration does to the graph as shown under section 105 of the interface authoring interface 100, as depicted according to the embodiment of FIG. 1. The administrator may further use elements from as many libraries as needed to create the final list of selected elements 104 in order to create a visualization authorizing interface with as many or as few libraries' functionalities as required.

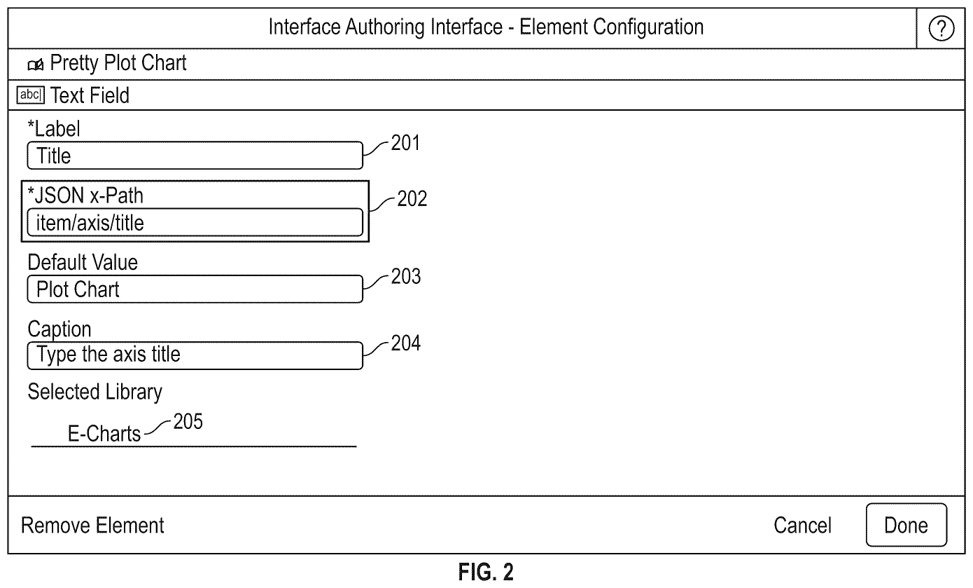

FIG. 2 depicts a second level of the interface authoring interface 100 generated by the system, for providing further customization opportunities to the administrator, according to some embodiments of the present disclosure. Once the elements, provided by the system generating the interface authoring interface 100, have been added to the selected element list 104, the system may receive a user input selection of an element and, in response, generate for display a second level interface authoring interface that allows for inputs altering further the settings specific to that selected element. In some embodiments, the specific settings may include a label 201, a JSON (JavaScript Object Notation) path 202, a default value 203, a caption 204 and the selected library 205. The label 201 may describe the specific element that has been selected and the setting of which are being altered by the administrator. The JSON path 202, default value 203, caption 205 and selected library 205 are the specific configurations belonging to the selected element. The administrator may edit these configurations to customize the selected element per the needs of the organization and its users. In some embodiments, initial code found in FIG. 2 (e.g., path in element 203) may be automatically generated based on selections made in interface authoring interface 100 of FIG. 1.

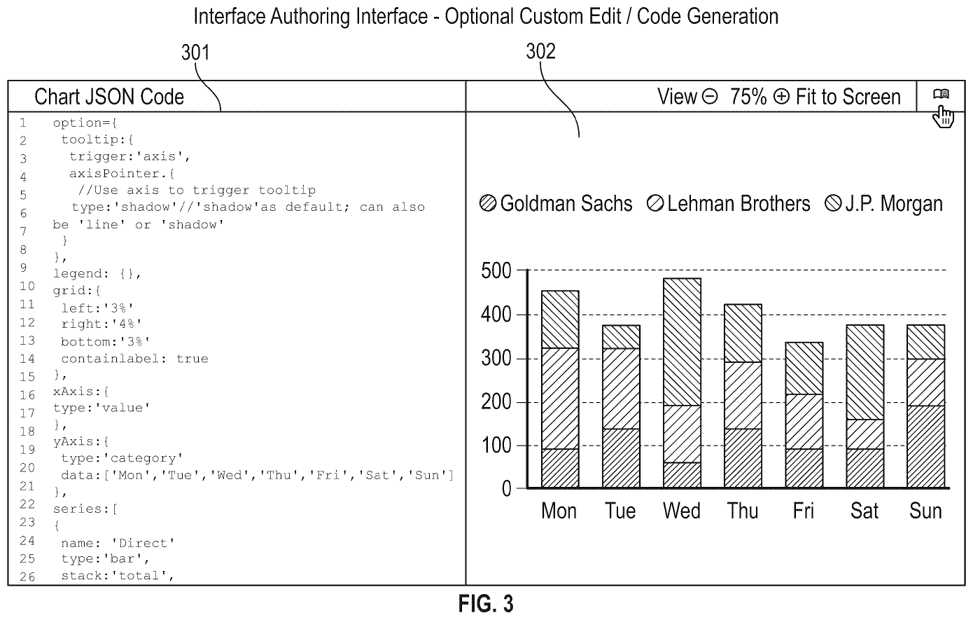

FIG. 3 depicts a code generation and custom code edit screen as part of the interface authoring interface (e.g., interface authoring interface 100 of FIG. 1), according to some embodiments of the present disclosure. In some embodiments, selection of elements shown in FIG. 1 results in automatic generation of code 301. In this way, element selection in authoring interface 100 virtualizes code generation (e.g., selection of different options via authoring interface 100 results in generation of suitable code matching the selection). In some optional embodiments, the administrator may be provided with a user interface option enabling review and or editing of the self-generating code or a portion of the self-generating code while utilizing the interface authoring interface 100. Upon making the selections and configuring the several elements per the organization requirements, the system further provides the administrator the ability to review the code generated from the one or more libraries, as depicted in the embodiment of FIG. 3.

In some embodiments, the generated code may be displayed by the system on one portion of the screen 301, and a preview visualization based on the selected elements may be displayed on another portion of the screen 302, as shown in the embodiment of FIG. 3. The system further provides the administrator the ability to use the first displayed screen 301 to review code (e.g., JSON code) generated by altering the configuration of the selected elements. The administrator may further be able to use the generated interface authoring interface to make edits to the generated code as needed to further finetune the selected element. Based on the selections made by the administrator on the interface authoring interface, each element selected extracts the relevant code from the library to which the element belongs, incorporating its own database of software code. This code is then automatically added to the application software so as to incorporate the selected elements into the application, thereby allowing the system to generate the element as a selection item on the visualization authoring interface.

Once the system has received, via the interface authoring interface 100, configuration settings and selections for all of selected elements of one more libraries, the system may further generate for display (e.g., to allow for review) the visualization authoring interface that will be used by other users to utilize the application to generate charts, graphs etc. per their selections. The visualization authoring interface may be generated by the system based on the elements selected by the administrator in the interface authoring interface. The generated visualization authoring interface provides the user with options to select and alter the different elements from one or more visualization libraries based on the configuration settings set by the administrator in the interface authoring interface 100, during the course of using the visualization application.

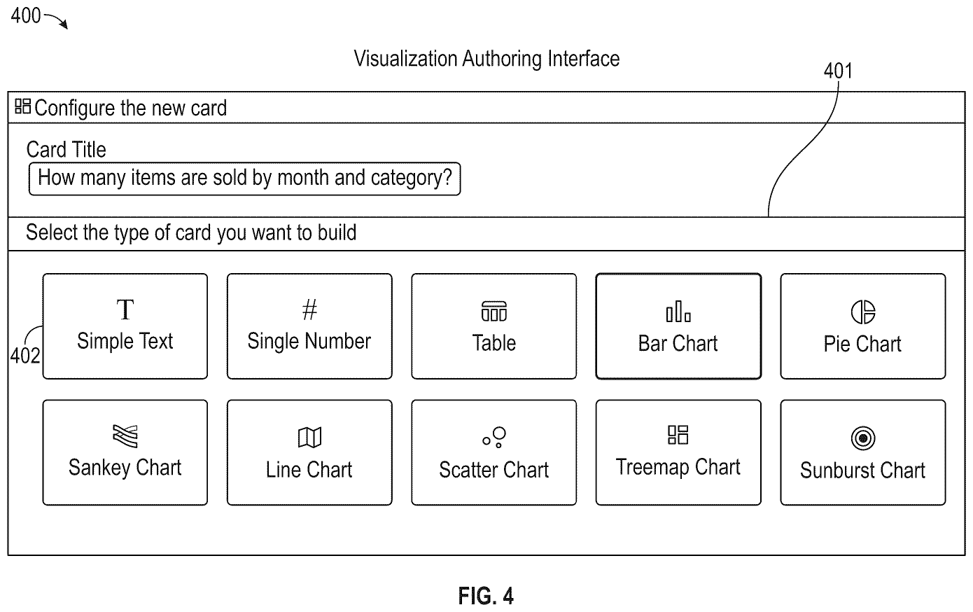

FIG. 4 depicts an exemplary first selection screen 400 of a visualization authoring interface 400, according to some embodiments of the present disclosure. Based on the selections made (e.g., by the administrator) in the interface authoring interface 100, the system generates a visualization authoring interface 400. The system may display the visualization authoring interface 400 to allow for use selection of visualization elements charts, graphs, tables etc. that they would like to generate. In some embodiments, the selection is limited to a set of selected options from selected libraries that were included by an administrator using interface authoring interface 100.

In some embodiments, visualization authoring interface 400 generates for display a screen where the user may enter a title for their visualization 401 and a selection of a type of visualization (chart, graph, table etc.) that they would like to generate 402. As discussed above with reference to FIGS. 1 and 2, the different options presented to the user in the visualization authoring interface 400 may be based on the selections made by the administrator during their selection and element configuration process provided to the administrator by the system using the interface authoring interface 100.

Although FIG. 4 depicts ten different kinds of visualizations available to the user to select from, it is known to one of ordinary skill in the art that the number of different types of visualizations are not limited thereto and the total options available to the user may be more or less.

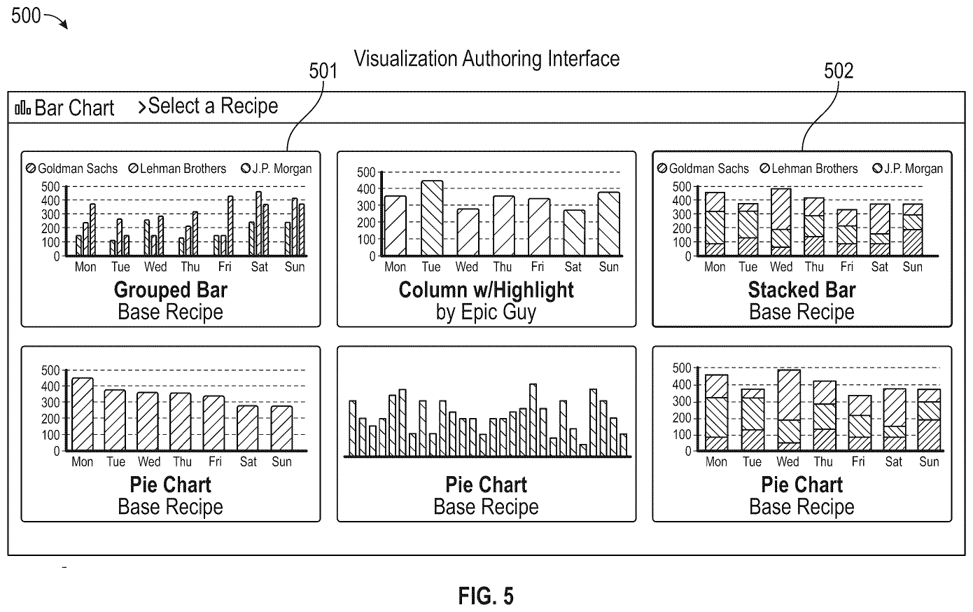

FIG. 5 depicts a second selection screen 500 of a visualization authoring interface, according to an embodiment of the present disclosure. In some embodiments, based on the selection made by the user on the first selections screen of the visualization authoring interface, the system may generate for display second selection screen 500 to further narrow down the selections. The specific options provided by the system to the user in the second selection screen are further based on the configuration setting selected by the administrator in the interface authoring interface.

In the embodiment depicted in FIG. 5, when user input selects a bar chart in the first selection screen is received by the system, the system generates for display a second selection screen of the visualization authoring interface offering a selection of several types of bar charts 501, to allow for input that further narrows down the type of bar chart. The difference in the types of bar charts available may be the way in which the bar charts are laid out, the colors and other visual presentations used to generate the bar charts, the stacking format used in the different styles of bar charts or other differentiating features.

The system may provide a plurality of different types of bar charts to the user in the second selection screen 500, based on the selections made by the administrator in the interface authoring interface 100, presented to the administrator by the system as described above with reference to FIG. 1. The second selection screen 500 may also differ based on the selections made by the user in the first selection screen. For example, if the user input was received that selected tables instead of bar charts in the first selection screen, then the second selection screen of the visualization authoring interface may depict the different kinds of tables available to the user instead of the different kinds of bar charts.

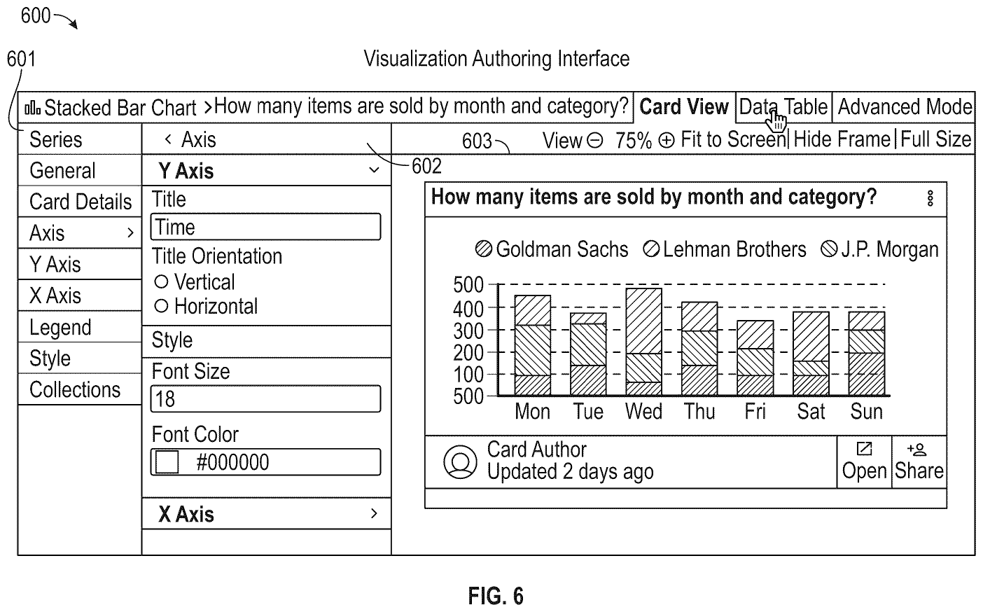

Once the system generates for display the second selection screen 500, the second selection screen enables a user interface selection (e.g., by the user) of appropriate bar charts 502. Once the system received a selection of a specific bar chart in the second selection screen, the user is presented with a third selection screen (e.g., screen 600 of FIG. 6) where user interface elements for making detailed adjustments to how the selected bar chart should be displayed.

FIG. 6 depicts a third selection screen 600 of a visualization authoring interface, according to an embodiment of the present disclosure. Although a first selection screen 400, a second screen 500 and a third selection screen 600 are depicted, it is known by one of ordinary skill in the art that the number of screens may be more or less while still remaining within the scope of the present disclosure. In some embodiment selection screen 600 may be generated for display by the system on its own or in any order with other screens of visualization authoring interface discussed herein.

In some embodiments, once the system receives a use interface selection via visualization authoring interface (e.g., selecting the kind of bar chart is to be displayed), third selection screen 600 is generated for display by the system to enable input for making final adjustments for customize the visualization (e.g., the bar chart). For example, system may generate for display user interface depicting first selection column 601, a second selection column 602 and a final display column 603, as depicted in the embodiment of FIG. 6. These selection options available in the visualization authoring interface are elements that were selected by the administrator based on the interface authoring interface 100 as provided to the administrator by the system. Although three selection columns are shown in the example of FIG. 6, it is not limited thereto and based on the settings and selections available to the user based on the administrator's settings in the interface authoring interface 100, additional columns may be generated and displayed by the system and so as to provide the user with the ability to further customize the bar chart.

As a result of selections made by the visualization authoring interface, the system generates a visualization using selected options from one or more libraries. The visualization may be generated for display, stored in non-volatile memory of the system, and/or transmitted to other devices (e.g., for display) using one or more suitable networks.

The functions performed by the system, e.g., in generating interface authoring interfaces, generating visualization authoring interface, displaying such interfaces, and processing input performed by such interfaces may be performed by a visualization application. For example, the system may store in its non-transitory memory instructions for running visualization application. When a processor of the system executes such instructions, the visualization application causes the processor to perform the functions described above and below.

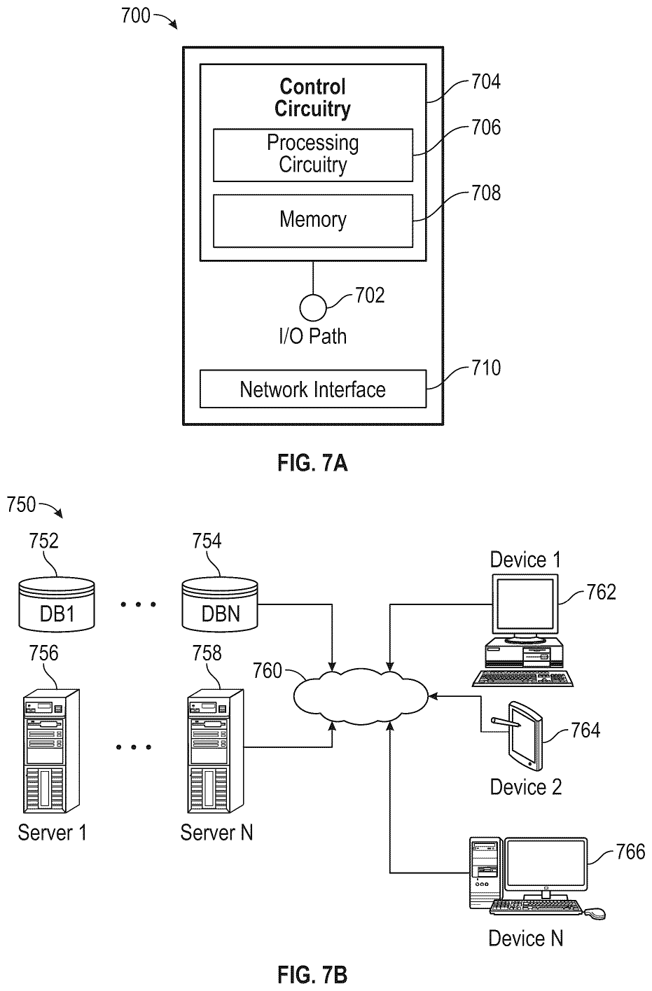

FIG. 7A shows a generalized embodiment of a device usable to provide data processing and visualization as described above and below. In particular, device 700 of FIG. 7 may be any of the devices that perform steps described in FIGS. 1-6. Device 700 may receive data via data network interfaces 710 and provide the received data to control circuitry 704 via an input/output (I/O) path 702. Control circuitry 704 includes processing circuitry 706 and storage 708. Storage 708 may include volatile memory 1230 (such as random-access memory (RAM), for example, static RAM and/or dynamic RAM), which does not retain its contents when power is turned off, and non-volatile memory 708 (such as, for example, a solid-state drive (SSD), a hard disk drive (HDD), electrically erasable programmable read-only memory (EEPROM), etc.), which does retain its contents when power is turned off. Control circuitry 704 may send and receive commands, requests, and other suitable data using I/O path 702. As noted above, I/O path 702 connects control circuitry 704 (and specifically processing circuitry 706) to network interface 710, which in turn connects device 700 to one or more other devices. For example, I/O path 702 may be used by one or more servers to received local or remote user interface input and provide visualization output to remote devices.

Control circuitry 704 may be based on any suitable processing circuitry, such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, octa-core, or any suitable number of cores). In some embodiments, processing circuitry is distributed across multiple separate processors or processing units, for example, multiple of the same type of processing units (e.g., two INTEL CORE i7 processors) or multiple different processors (e.g., an INTEL CORE i5 processor and an INTEL CORE i7 processor). In some embodiments, control circuitry 704 executes instructions suitable to implement any of the techniques described above or below.

Storage 708 may be an electronic storage device that is part of control circuitry 704. As referred to herein, the phrase “electronic storage device” or “storage device” should be understood to mean any device for storing electronic data, computer software, instructions, and/or firmware, such as RAM, content-addressable memory (CAM), hard disk drives (HDDs), optical drives, solid state devices (SSDs), quantum storage devices, or any other suitable fixed or removable storage devices, and/or any combination of the same. The circuitry described herein may execute instructions included in software running on one or more general purpose or specialized processors. In some embodiments, storage 708 may include a set of instruction, that when executed by control circuitry 704 result in execution and operation of the visualization application as described by FIGS. 1-6. In some embodiments, device 700 may comprise user interface circuitry for receiving user input (e.g., via keyboard, mouse, touch screen or any other suitable user input device). user interface circuitry may provide input data to control circuitry 704.

FIG. 7B shows a diagram of an illustrative system 750 for performing data analysis and user interface presentation, in accordance with embodiments described in FIGS. 1-6. For example, system 750 includes any number of servers 756-758 that may be configured to perform all aspects of the visualization application as described as above and below. For example, the visualization application may be executed by any of the servers 756-758 or by a combination of servers using suitable distributed computing techniques. Servers 756-758 may be communicatively connected to any number of databases 752-754 by local connection or via network 760. Network 760 may be any kind of a suitable network, such as Internet, intranet, private network, virtual network, cellular network, or any combination the above.

System 750 may include any number of client devices 762-766 (e.g., PCs, computers, smartphones, laptops, PDA, or any other suitable computer devices). Client devices 762-766 may be configured to interface with servers 756-758 via network 760. Client devices 762-766 may be configured to provide UI input to servers 756-758, e.g., to define the semantic overlay data structure for tadeonal data sources (e.g., stored on Databases 752-754). Client devices 762-766 may be configured to provide query input to the visualization application executing on servers 756-758. Client devices 762-766 may be configured to received output provided the visualization application executing on servers 756-758. For example, client devices 762-766 may display visualizations and query results provided the visualization application generated for display by servers 756-758 via network 760. Each of devices 762-766, 756-758, and 752-754 may comprise hardware as shown by FIG. 7A and/or any other suitable hardware.

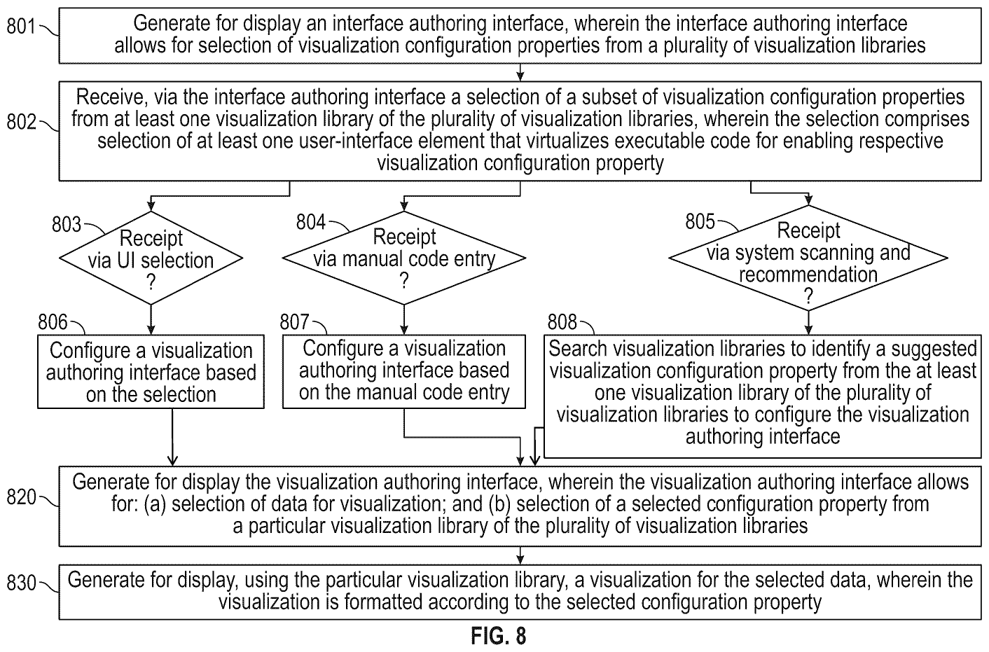

FIG. 8 shows a flowchart of an illustrative process to generate a visualization authoring interface, according to an embodiment of the present disclosure.

The process 800 begins at 801 by the system displaying an interface authoring interface (e.g., using processing circuitry 706). As described above with reference to FIGS. 1-3, the system may generate for display an interface authoring interface to enable selection and configuration of one or more visualization configuration properties from a plurality of visualization libraries (e.g., properties that an administrator wishes would be visible for selection via visualization authoring interface). The interface authoring interface may be used (e.g., by an administrator user) to make numerous visualization configuration properties selections from one more visualization libraries. The selection may be made by manual selection of the configuration properties, by selection of recommended configuration properties, or by manually entry of code linking to one or more visualization libraries.

For example, at 802, a selection of configuration properties is received using the processing circuitry 706. The selection may identify a subset of all properties available from all suitable libraries (e.g., publicly accessible libraries accessible via the Internet). The selections can me made e.g., as shown in FIGS. 1-3.

The processing circuitry 706 may receive and process the selection (e.g., from the administrator user) to determine how the visualization authoring interface (e.g., as shown in FIG. 6) may be generated. In particular, the selections may virtualize executable code for enabling respective visualization configuration properties. For example, each selectable element may result in the system generating executable code for accessing the selected property from the selected library (e.g., from the web API of that library). Such code may enable the visualization authoring interface to access the selected property form the associated library.

At 803, the processing circuitry 706 processes a received selection made via user interface (e.g., by receiving input of a keyword that identifies the selection of the subset of visualization configuration properties.). For example, the selection may have been made by user interface search that included clicking on of plurality of configuration options for the different elements (e.g., from a full list of all options available from all suitable libraries or from a particular library). In this case, the processing circuitry 706, at 806, configures the visualization authoring interface based on the selections made through the user interface.

At 805, the processing circuitry 706 processes input via property recommendation option. This option may be shown automatically or response to user interface request. In this case, the processing circuitry searches through the visualization libraries to identify a suggested visualization configuration property from the at least one visualization library of the plurality of visualization libraries, and configures the visualization authoring interface based on the search. The recommendation may be based, e.g., on historic popularity of certain configuration elements or by analysis of data that will need to be visualized.

For example, processing circuitry 706 may search at least one of the plurality of visualization libraries to identify a suggested visualization configuration property from the at least one visualization library of the plurality of visualization libraries. The processing circuitry 706 may then generate for display a user interface element indicative of the identified suggested visualization configuration property (e.g., a label or a button). processing circuitry 706 may then receive user interface input indicative of the identified suggested visualization configuration property (e.g., by a click or touch) of a user interface element indicative of the identified suggested visualization configuration property. The selected property is then added to the visualization authoring interface.

At 804, processing circuitry 706 process input of user manually entered software code to make the selections of the configuration properties for the elements to be included in the visualization authoring interface. If it is determined that manual code was entered by the administrator, at 807, the processing circuitry 706 configures the visualization authoring interface with elements based on the software code manually entered by the administrator.

Steps 803-806, 804-807, and 805-808 may be performed individually, simultaneously or in any order.

At step 820, the processing circuitry 706 generates for display (e.g., using I/O path 702) the visualization authoring interface, wherein the visualization authoring interface allows for: (a) selection of data for visualization; and (b) selection of a selected configuration property from a particular visualization library of the plurality of visualization libraries. For example, the visualization authoring interface (e.g., as shown in FIG. 6) may be limited to options selected at steps 803-808 made e.g., via interface authoring interface as shown in FIG. 801.

At step 830, the processing circuitry 706 generating for display e.g., using I/O path 702), using the particular visualization library, a visualization for the selected data, wherein the visualization is formatted according to the selected configuration property and is based on data selected at step 820. For example, the processing circuitry 706 may access selected libraries using executed code that was generated based on selections made at steps 802-808. An example of such visualization is provided, e.g., in element 603 of FIG. 6.

In some embodiments, processing circuitry 706 when generating for display a visualization authoring interface may determine that the same type of configuration property is available from different visualization libraries (e.g., due to such a selection via an interface authoring interface). In this case, the visualization authoring interface may group the same type of configuration property from different visualization libraries proximate to each other. In some embodiments, processing circuitry 706 may generate for display via the visualization authoring interface a plurality of previews of visualizations for the selected data using each of the same type of configuration properties from each of the plurality of visualization libraries. For example, different a chart with different types of axis labels (e.g., provided by two different libraries) may be generated (e.g., simultaneously) proximate to each other.

In some embodiments, processing circuitry 706, allows for generation of a recipe for a particular data type, wherein the recipe defines a plurality of configuration properties from a particular visualization library of the plurality of visualization libraries. Such recapture may then be reused when the visualization authoring interface is used later. For example, in response to the selection of the recipe, processing circuitry 706 may generate for display, using the particular visualization library, a visualization for the selected data, wherein the visualization is formatted according to the plurality of configuration properties of the recipe. The recopied may also be modified via visualization authoring interface, e.g., to select one or more of options made available by selection via interface authoring interface.

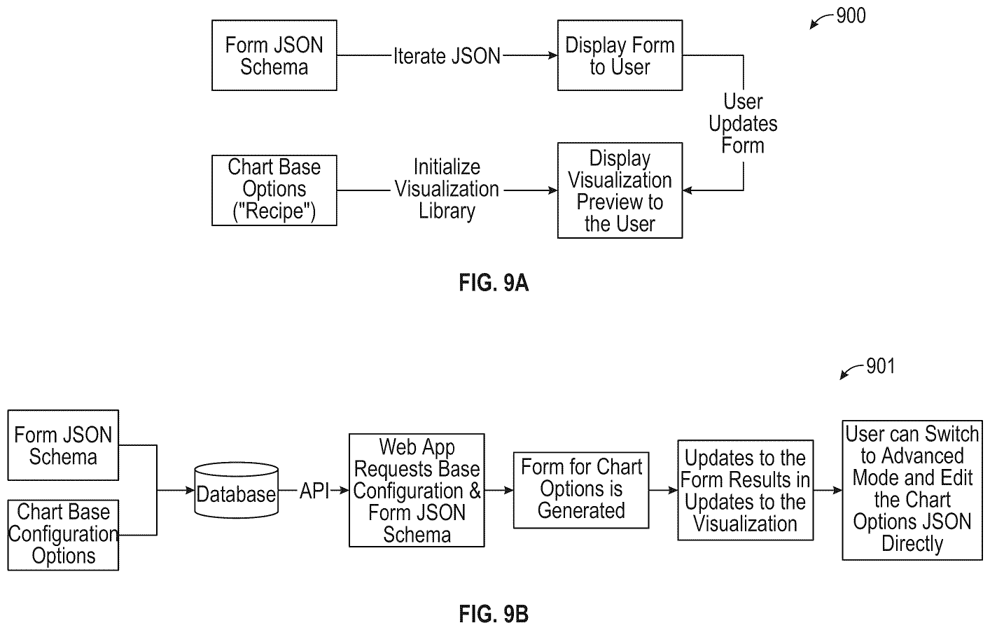

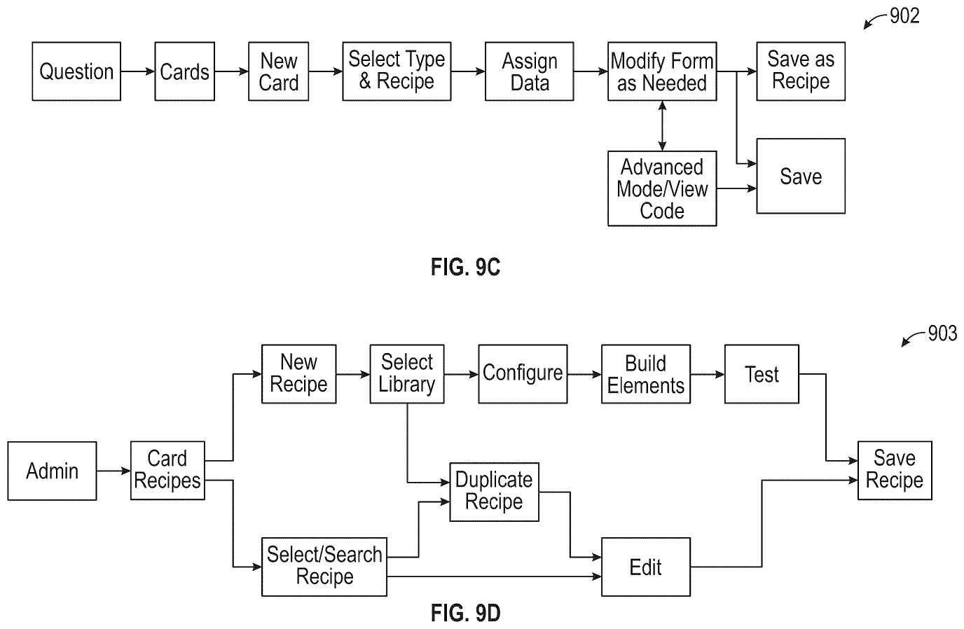

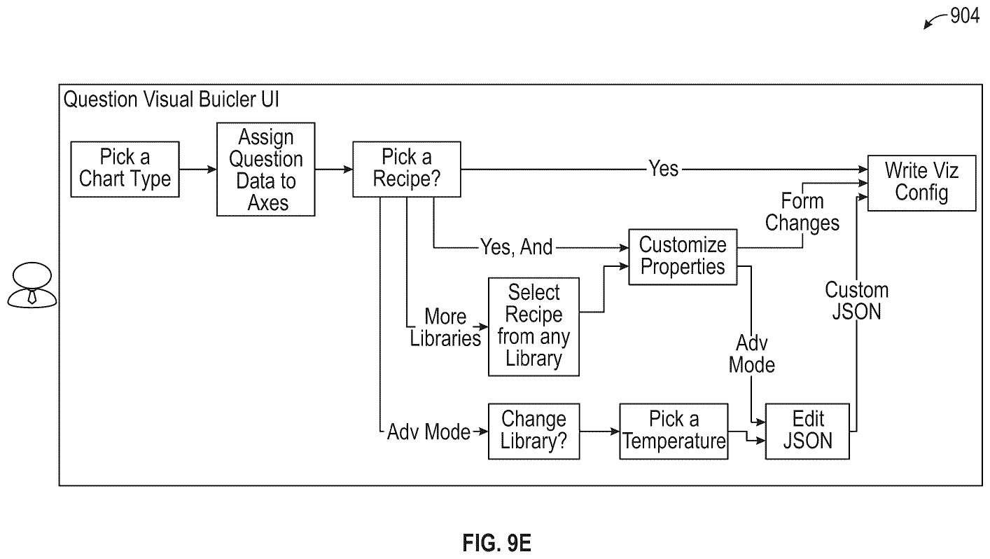

FIGS. 9A-9E show flowcharts of an illustrative processes for library mapping and chart authoring, according to an embodiment of the present disclosure.

FIG. 9A depicts methods 900 for operation the visualization application. As shown, the system may form JSON schema (e.g., using inputs from user interface of interface authoring interface) and use JSON schema to display a form to a user (e.g., as part of visualization authoring interface). User updates to the form may be processed resulting in the display of visualization. In another embodiment, visualization application begins with a based recipe (e.g., created using interface authoring interface) to immediately display a visualization.

FIG. 9B depicts methods 901 for operation the visualization application. In the shown example, the method may begin from formation of the JSON schema (e.g., using interface authoring interface) and/or from formation of visualization recipes (e.g., interface authoring interface). The schema and recipes may be stored in a database. Later the databases may be accessed by the visualization application (e.g., to display a visualization authoring interface) via an API request. For example, the visualization (e.g., acting as a web application) may request the JSON scheme from the database. The visualization application may then generate for display the chart options (e.g., as part of visualization authoring interface). After chart options are modified, visualization authoring interface is caused to generate for display an updated visualization in the visualization authoring interface. In some embodiments user interface input may be received that causes a switch to advanced mode allowing modification to JSON directly.

FIG. 9C depicts methods 902 for operation the visualization application. In the shown example, use flow of a visualization authoring interface is shown.

In the shown example, the visualization application may first receive a query to stored data. The visualization application may then show appropriate cards for the query. In on embodiment, an option to use a new card is selected. The term “card” refers to a type of an implementation of a visualization (e.g., a visualization being defined in the visualization authoring interface), e.g., where the visualization appears bounded by a box, or any other suitable type of visualization.

In this example, the visualization application receives a selection of a visualization type and a selection of recipe. The visualization application also receives selection of data to be visualized. At this point, the visualization application may display a preview of visualization of the selected data using the selected visualization recipe. In one approach, the user may modify the form, and potentially save the modified form as a new recipe. In another approach, the modification may be performed in advanced mode (e.g., by direct edits to the code).

FIG. 9D depicts methods 903 for operation the visualization application. In the shown example, user interface use flow (e.g., by administrator user) is shown, e.g., as part of operation of interface authoring interface.

In one shown example, the interface authoring interface begins with a list of card recipes. Once a recipe is selected, options to edit the recipe are shown. The edited recipe is than saved.

In another shown example, input to create a new recipe is selected. In one example, new recipe is initially copied from an existing recipe, modified, and saved. In another example, the user interface authoring interface prompts selection of a library, follows by configurations of the options and selection of elements from the selected library (e.g., as shown in FIGS. 1 and 2). In some embodiments, a test of the selected options and elements is performed (e.g., by generation of a preview of a visualization authoring interface based on selected options and elements). The resulting recipe is than saved.

FIG. 9E depicts methods 904 for operation the visualization application. In the shown example, user interface use flow (e.g., by a user) is shown, e.g., as part of operation of visualization authoring interface.

In the shown example, a user uses the visualization authoring interface to selects a chart type (e.g., a bar graph, scatter plot etc.) The visualization application may then prompt and receive an input assigning question data to axes.

The visualization application may then display a prompt to pick a recipe. If a receive is picked, the visualization authoring interface is caused to display the visualizing using the selected recipe (e.g., as configured using interface authoring interface). In another embodiment, user may choose to customize properties after selection of the recipe. In this approach, the visualization is updated as the properties are changed.

In another example, the user may be further promoted to selected among multiple libraries, resulting in more choices of recipes from each library. In another example, the user may use advanced mode to change the library, pick a template, and modify the code of the template manually.

Further techniques for operation of exemplary interface authoring interfaces and the visualization authoring interface are provided that may be used instead or in addition to the techniques describe above.

In some embodiments, access to web visualization libraries may be configured by selection of metadata elements as part of operation of the interface authoring interface. For example, visualization libraries may be included in the distribution of a visualization application with a web interface. The libraries may be incorporated into a visualization authoring user interface rendered in a web browser. The visualization authoring interface may render of one or more elements defined by the library (i.e., one or more charts, graphs, etc.) in a manner defined by the interface authoring interface.

In some embodiments, configuration of each referenced library element (i.e., a chart) may be done individually from others with details of each configuration defined by stored metadata. Configuration options in the stored metadata may be defined by an application user (e.g., by and administer), such that a new chart element which has not been configured before can be configured by a user without additional software development to “wire” that library configuration element.

In some embodiments, at chart authoring time, a form or other interface may be provided to the user (e.g., via visualization authoring interface) to enter values for all configured configuration properties. At chart authoring time, the user may also be able to make modifications directly to the configuration document for the chart. At runtime, when a chart is displayed, the visualization application may merge a base configuration document (stored for each library) with the configured properties for this chart instance, and displays the resulting chart to the user.

In some embodiments, the library mapping for configuring visualization authoring interface may be performed as follows:

Metadata records may be provided via the interface authoring interface to tie a configuration property from a library to a user-defined property name. Such records may include a reference to the specific library being configured. Such records may include a reference to the location of the property within the configuration document (e.g., XML or JSON) used by the library. In one approach, the location may be represented in, e.g., the XPath format.

In some embodiments, records may include a reference to the type of the configuration property. For example, exemplary options may include text, enumerations (lists of potential values), numbers, color definitions, ranges of numbers, any other suitable visualization UI element, and any combination of the above. In some example, records may include validation or range information for the configuration property. (i.e., for numbers, the allowed range may be specified to only accept values between 0 and 100.). The records may provide an anchor for key details about the library configuration. The records also allow for alignment of similar configuration concepts between libraries.

In some embodiments, application of configuration metadata may be performed as follows:

Visualization libraries may have a standard configuration document (XML or JSON) which defines behavior and appearance of each instance where the library is used (i.e., for each chart). Each included visualization library may have a “base” configuration document containing basic structure, immutable fields, etc. In some embodiment, the configuration defined for each chart (as described herein by use of interface authoring applications) may be applied to this base document to add additional configuration properties and their values, or to change the values of default properties.

In some embodiments, user configuration of metadata may be performed as follows:

In the library metadata may defines all the configuration properties that the visualization application “knows about”. In some embodiments, user interface input may be received to configure an instance of a char by setting values for one or more of those properties. In one approach, the input is received via a form filled out by the user (e.g., where fields of the form define the metadata for all available library mappings).

In one approach, the form is improved, structuring user-defined names of each property into a number of groups or levels in a hierarchy (each having a name) such that like-properties can be grouped together. In some embodiments, default values, range limitations, etc., as defined in the library mappings can be provided via the user interface at this time as well, and be used to validate their input. For example, default values, range limitations, etc., may further be defined in the library mappings.

In some embodiments, custom manipulation of configuration documents outside of configuration metadata may be performed as follows:

As discussed above, defining metadata (e.g., via interface authoring interface) to allow a user to configure a library (and control the degree of configuration possible) via forms has benefits, a user may still want to directly edit the text of the configuration document. This may, for example, allow a user to quickly test the functionality of a given configuration property without having to navigate the library mapping workflow. This techniques may complicate the merging process described above, where a base image is merged with configuration metadata and also with custom text-level edits to the document. To solve issue, if the visualization configuration is going to be subsequently still editable at a form level, logic may be provided to modify a copy of the base document such that it can continually be merged with form-driven changes despite the manual editing.

In some embodiments, storing preset chart configurations may be performed as follows:

During chart authoring, a set of values for one or more library mappings may be received via input by a user and stored associated with one instance of a chart. To avoid continually entering similar configurations, a chart configuration may be stored (“promoted”) as a recipe to be reused. During subsequent use of the chart authoring flow, a named recipe can be selected and either left unmodified or used as a starting point for additional customization.

The above disclosure is meant to be illustrative and not limiting. Only the claims that follow are meant to set bounds as to what the present invention includes. Furthermore, it should be noted that the features and limitations described in any one embodiment may be applied to any suitable other embodiment herein, and flowcharts or examples relating to one embodiment may be combined with any other suitable embodiment in a suitable manner, done in different orders, or done in parallel. In addition, the systems and methods described herein may be performed in real time. It should also be noted that the systems and/or methods described above may be applied to, or used in accordance with, other systems and/or methods.

It will be apparent to those of ordinary skill in the art that systems and methods involved in the present disclosure may be embodied in a computer program product that includes a non-transitory computer-usable and/or -readable medium. For example, such a non-transitory computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

What is claimed is:

1. A method for data presentation, the method comprising:
generating for display an interface authoring interface, wherein the interface authoring interface allows for selection of visualization configuration properties from a plurality of visualization libraries;
receiving, via the interface authoring interface a selection of a subset of visualization configuration properties from at least one visualization library of the plurality of visualization libraries, wherein the selection comprises selection of at least one user-interface element that virtualizes executable code for enabling respective visualization configuration property; and
configuring a visualization authoring interface based on the selection received via the interface authoring interface, wherein the visualization authoring interface is configured using the executable code.

2. The method of claim 1, further comprising:
generating for display the visualization authoring interface, wherein the visualization authoring interface allows for: (a) selection of data for visualization; and (b) selection of a selected configuration property from a particular visualization library of the plurality of visualization libraries; and
generating for display, using the particular visualization library, a visualization for the selected data, wherein the visualization is formatted according to the selected configuration property.

3. The method of claim 1, wherein the receiving further comprises receiving input of a keyword that identifies the selection of the subset of visualization configuration properties.

4. The method of claim 1, further comprising:
searching at least one of the plurality of visualization libraries to identify a suggested visualization configuration property from the at least one visualization library of the plurality of visualization libraries; and
generating for display a user interface element indicative of the identified suggested visualization configuration property;
wherein the receiving comprises receiving user interface interaction with the displayed user interface element indicative of the identified suggested visualization configuration property.

5. The method of claim 1, wherein the subset of visualization configuration properties comprises less configuration properties than available from each of the plurality of visualization libraries.

6. The method of claim 1, wherein the visualization authoring interface comprises the same type of configuration property from different visualization libraries.

7. The method of claim 6, wherein the visualization authoring interface groups the same type of configuration property from different visualization libraries proximate to each other.

8. The method of claim 6, further comprising:
generating for display via the visualization authoring interface a plurality of previews of visualizations for the selected data using each of the same type of configuration properties from each of the plurality of visualization libraries.

9. The method of claim 8, wherein the previews are generated for display simultaneously.

10. The method of claim 1, wherein the interface authoring interface allows for generation of a recipe for a particular data type, wherein the recipe defines a plurality of configuration properties from a particular visualization library of the plurality of visualization libraries.

11. The method of claim 10, wherein the visualization authoring interface comprises an option to select the recipe for the particular data type, and
in response to the selection of the recipe, generating for display, using the particular visualization library, a visualization for the selected data, wherein the visualization is formatted according to the plurality of configuration properties of the recipe.

12. The method of claim 11, wherein the visualization authoring interface comprises an option to modify the recipe for the particular data type.

13. The method of claim 1, wherein configuring the visualization authoring interface according to the selected configuration property comprises querying the particular visualization library via a network.

14. The system comprising:
control circuitry configured to:
generate for display an interface authoring interface, wherein the interface authoring interface allows for selection of visualization configuration properties from a plurality of visualization libraries;
input/output circuitry configured to:
receive, via the interface authoring interface a selection of a subset of visualization configuration properties from at least one visualization library of the plurality of visualization libraries, wherein the selection comprises selection of at least one user-interface element that virtualizes executable code for enabling respective visualization configuration property; and
wherein the control circuitry is further configured to:
configure a visualization authoring interface based on the selection received via the interface authoring interface, wherein the visualization authoring interface is configured using the executable code.

15. The system of claim 14,
wherein the control circuitry is further configured to:
generate for display the visualization authoring interface, wherein the visualization authoring interface allows for: (a) selection of data for visualization; and (b) selection of a selected configuration property from a particular visualization library of the plurality of visualization libraries; and
generate for display, using the particular visualization library, a visualization for the selected data, wherein the visualization is formatted according to the selected configuration property.

16. The system of claim 14, wherein the control circuitry is further configured to receive an input of a keyword that identifies the selection of the subset of visualization configuration properties.

17. The system of claim 14, wherein the control circuitry is further configured to:
search at least one of the plurality of visualization libraries to identify a suggested visualization configuration property from the at least one visualization library of the plurality of visualization libraries; and
generate for display a user interface element indicative of the identified suggested visualization configuration property;
receive user interface interaction with the displayed user interface element indicative of the identified suggested visualization configuration property.

18. The system of claim 14, wherein the subset of visualization configuration properties comprises less configuration properties than available from each of the plurality of visualization libraries.

19. The system of claim 14, wherein the visualization authoring interface comprises the same type of configuration property from different visualization libraries.

20. The system of claim 19, wherein the visualization authoring interface groups the same type of configuration property from different visualization libraries proximate to each other.

21. The system of claim 19, wherein the control circuitry is further configured to:
generate for display via the visualization authoring interface a plurality of previews of visualizations for the selected data using each of the same type of configuration properties from each of the plurality of visualization libraries.

22. The system of claim 21, wherein the previews are generated for display simultaneously.

23. The system of claim 14, wherein the interface authoring interface allows for generation of a recipe for a particular data type, wherein the recipe defines a plurality of configuration properties from a particular visualization library of the plurality of visualization libraries.

24. The system of claim 23, wherein the visualization authoring interface comprises an option to select the recipe for the particular data type, and
wherein the control circuitry is further configured to, in response to the selection of the recipe, generate for display, using the particular visualization library, a visualization for the selected data, wherein the visualization is formatted according to the plurality of configuration properties of the recipe.

25. The system of claim 24, wherein the visualization authoring interface comprises an option to modify the recipe for the particular data type.

26. The system of claim 14, wherein the control circuitry is further configured to query the particular visualization library via a network.
